(19) United States
(12) Patent Application Publication
(10) Pub. No.: US 2017/0134327 A1
(43) Pub. Date: May 11, 2017

(54) METHOD AND DEVICE FOR NOTIFYING MOBILE TERMINAL OF UNREAD INFORMATION

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Boyuan Liu, Tianjin (CN)

(21) Appl. No.: 15/227,650

(22) Filed: Aug. 3, 2016

Related U.S. Application Data
(63) Continuation of application No. PCT/CN2016/082141, filed on May 13, 2016.

(30) Foreign Application Priority Data
Nov. 11, 2015 (CN) 201510765818.7

(51) Int. Cl. H04L 12/58; H04W 4/14; H04L 29/08

(52) U.S. Cl. CPC H04L 51/24; H04L 67/26; H04W 4/14; H04W 88/02

(57) ABSTRACT

Embodiments of the disclosure provide a method and apparatus for notifying a mobile terminal of unread information, and relate to the field of mobile communications, where the method includes: receiving, by a server, the unread information reported by the mobile terminal; determining, by the server, a display terminal bound with the mobile terminal according to a binding relationship between the mobile terminal and the display terminal; and pushing, by the server, the unread information reported by the mobile terminal, to the display terminal bound with the mobile terminal upon determining that the display terminal has been powered on, so that a user watching TV can be notified in a timely manner of the unread information, so as to address the problem in the prior art the user watching TV can not be notified in a timely manner of the unread information in the mobile terminal.

### CROSS REFERENCE TO RELATED APPLICATIONS

This application is a continuation of International Application No. PCT/CN2016/082141, filed on May 13, 2016, which is based upon and claims priority to Chinese Patent Application No. 201510765818.7, filed on Nov. 11, 2015, the entire contents of which are incorporated herein by reference.

### FIELD

The present disclosure relates to the field of mobile communications, and particularly to a method and device for notifying a mobile terminal of unread information.

### BACKGROUND

As the mobile terminal technologies have been developed, mobile phones have played a vital role in working and living of people. The functions of the existing mobile phones have become increasingly powerful, and various applications have emerged. The function of voice communication is one of the most important functions in mobile terminals in the field of wireless communication, and also one of the underlying functions in the mobile terminals, where users communicate with each other in real time over a wireless network using this function. In addition to voice communication, communication in short messages has also become a predominant real-time communication mode. In addition to these, information communication via e-mails at the mobile terminals has become increasingly popular as the Internet has been developed rapidly.

As the Internet has been developed rapidly, the traditional TV has come to speed up its advancement into the field of network TV, also referred to as Internet Protocol TV (IPTV), which is based upon the broadband high-speed IP network, handles network video resources, and uses a TV sets, a personal computers, and a handheld device as a display terminal, and accesses the broadband network through a set-top box or a computer, thus enabling digital TV, Time-shift TV, interactive TV, and other services; and the emergence of the network TV has brought people an innovative way of watching TV by changing the original passive mode of watching TV so that people watch TV over the network as needed, where people watch and stop TV conveniently at any time.

In implanting the process of the disclosure, the inventors of the disclosure have found that there is at least the relevant technical problem: occasionally if a user is watching TV at home, and his or her mobile phone is not carried therewith, then if there are unread calls, short messages, e-mails, or other unread information, then a common practice will be to collect the unread information into an unread information pop-up box upon detection of the unread information in the mobile phone, and to notify the user of the unread information in the actively popped-up unread information pop-up box to be viewed in a timely manner.

A drawback of the prior art lies in that if there is unread information in the mobile terminal while the user is watching a TV program, then the unread information missed on the mobile terminal will not be extracted until the user reaches the mobile terminal again, so that the user watching the TV program can not be notified in a timely manner about the unread information.

### SUMMARY

Embodiments of the disclosure provide a method for notifying a mobile terminal of unread information and an electronic device so that a user watching TV can be notified in a timely manner of the unread information, so as to address the problem in the prior art the user watching TV can not be notified in a timely manner of the unread information in the mobile terminal.

An embodiment of the disclosure provides a method for notifying a mobile terminal of unread information, the method including:

receiving, by a server, the unread information reported by the mobile terminal;

determining, by the server, a display terminal bound with the mobile terminal according to a binding relationship between the mobile terminal and the display terminal; and

pushing, by the server, the unread information reported by the mobile terminal, to the display terminal bound with the mobile terminal upon determining that the display terminal has been powered on.

An embodiment of the invention disclosure provides an electronic device, including:

at least one processor; and

a memory communicably connected with the at least one processor for storing instructions executable by the at least one processor, wherein execution of the instructions by the at least one processor causes the at least one processor to:

receive, by a server, the unread information reported by the mobile terminal;

determine, by the server, a display terminal bound with the mobile terminal according to a binding relationship between the mobile terminal and the display terminal; and

push, by the server, the unread information reported by the mobile terminal, to the display terminal bound with the mobile terminal upon determining that the display terminal has been powered on.

An embodiment of the invention disclosure provides A non-transitory computer-readable storage medium storing executable instructions that, when executed by an electronic device with a touch-sensitive display, cause the electronic device to:

receive, by a server, the unread information reported by the mobile terminal;

determine, by the server, a display terminal bound with the mobile terminal according to a binding relationship between the mobile terminal and the display terminal; and

push, by the server, the unread information reported by the mobile terminal, to the display terminal bound with the mobile terminal upon determining that the display terminal has been powered on.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed:

FIG. 1 is a flow chart of a method for notifying a mobile terminal of unread information in accordance with some embodiments;

FIG. 2 is a flow chart of a method for notifying a mobile ten al of unread information in accordance with some embodiments;

FIG. 3 is a flow chart of a method for notifying a mobile terminal of unread information in accordance with some embodiments;

FIG. 4 is a flow chart of a method for notifying a mobile terminal of unread information in accordance with some embodiments;

FIG. 5 is a schematic structural diagram of an apparatus for notifying a mobile terminal of unread information in accordance with some embodiments;

FIG. 6 is a schematic structural diagram of a user equipment for notifying a mobile terminal of unread information in accordance with some embodiments; and

FIG. 7 is a schematic structural diagram of a display terminal for notifying a mobile terminal of unread information in accordance with some embodiments.

FIG. 8 is a schematic structural diagram of an electronic device in accordance with some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

An embodiment of the disclosure provides a method for notifying a mobile terminal of unread information, where the method includes:

A server receives unread information reported by the mobile terminal; the server determines a display terminal bound with the mobile terminal according to a binding relationship between the mobile terminal and the display terminal; and the server pushes the unread information reported by the mobile terminal, to the display terminal bound with the mobile terminal upon determining that the display terminal has been powered on.

In the embodiment above of the disclosure, the server pushes the unread information uploaded by the mobile terminal to the display terminal bound with the mobile terminal upon reception of the unread information, where the server determines whether the display terminal has been powered on, before the unread information is pushed, and if the display terminal has been powered on, then the server will push the unread information to the display terminal, so that a user watching TV can be notified in a timely manner of the unread information to thereby improve the experience of the user so as to address the problem in the prior art that the user watching TV can not be notified in a timely manner of the unread information.

The embodiments of the disclosure will be described below in further details with reference to the drawings.

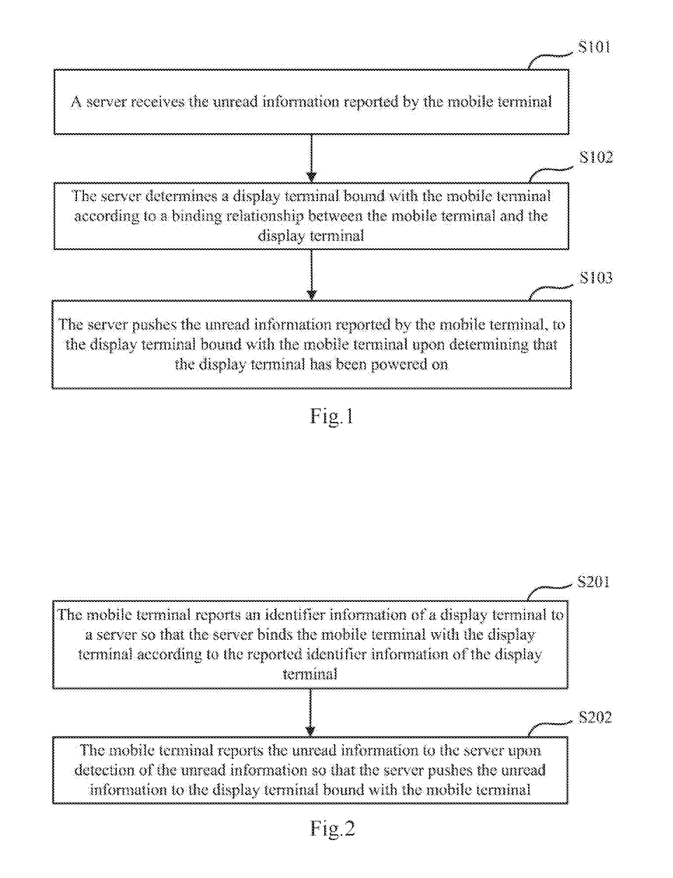

An embodiment of the disclosure provides a method for notifying a mobile terminal of unread information as illustrated in FIG. 1, the method including:

S101. A server receives the unread information reported by the mobile terminal;

S102. The server determines a display terminal bound with the mobile terminal according to a binding relationship between the mobile terminal and the display terminal; and

S103. The server pushes the unread information reported by the mobile terminal, to the display terminal hound with the mobile terminal upon determining that the display terminal has been powered on.

In the embodiment of the disclosure, the mobile terminal can be a mobile phone terminal, a tablet computer, a notebook computer, etc., and the display terminal can be a network TV device, a tablet computer, a tablet computer, etc.

Here in the operation S101, the unread information includes one or more of:

Unread call information;

Unread short message information; and

Unread e-mail information.

In an embodiment of the disclosure, the unread information includes one or more of unread call information, unread short message information, and unread e-mail information, or can be an unread to-do-list, an unread scratchpad, etc, so that a user watching TV can be notified of all the unread information.

Here in the operation S102, upon reception of the unread information reported by the mobile terminal, the server searches for the display terminal bound with the mobile terminal according to a terminal identifier of the mobile terminal reporting the unread information, and determines the display terminal bound with the mobile terminal.

Here in the operation S102, the server creates the binding relationship between the mobile terminal and the display terminal as follows:

The server binds the display terminal corresponding to the identifier of the display terminal with the mobile terminal upon reception of the identifier information of the display terminal reported by the mobile terminal.

In the embodiment above of the disclosure, the server determines for the reporting mobile terminal the identifier of the mobile terminal, creates a relationship index table between the display terminal and the mobile terminal in the server according to the identifier information of the display terminal reported by the mobile terminal, and the identifier of the mobile terminal, and stores the table in a database of the server.

The server can determine for the reporting mobile terminal a mobile phone number M1 of the mobile terminal, and create an index correspondence relationship according to the identifier information of the display terminal reported by the mobile terminal, for example, if the identifier of the display terminal is reported as D1, then the server will create an index correspondence relationship in the server, i.e., M1→D1, and write the correspondence relationship into the relationship index table of the server, so that the server searches the index relationship for the corresponding display terminal upon reception of the unread information reported by the mobile terminal.

Here after the operation S102, if the display terminal bound with the mobile terminal has been powered off, then the server will bind and store the identifier of the display terminal, and the unread information in a buffer area;

The server modifies the state of the corresponding display terminal to Powered On upon reception of power-on state information reported by the display terminal; and

The server detects the state of the corresponding display terminal in the buffer area periodically according to the identifier of the display terminal, and pushes the unread information bound with the identifier information of the display terminal to the corresponding display terminal upon determining that the state of the corresponding display terminal is Powered On.

If the display terminal has been powered on, then the server will locate in a memory the display terminal bound with the mobile terminal using the identifier of the mobile terminal, and push the unread information directly to the display terminal.

In the embodiment above of the disclosure, if the server receives the unread information reported by the mobile terminal, then the server will search for the display terminal bound with the mobile terminal using the identifier of the mobile terminal, and push the unread information to the display terminal; and if the display terminal has been powered off, then the server will bind and store the identifier information of the display terminal and the unread information in the buffer area, so that the unread information can be displayed in a timely manner on the display terminal after the display terminal is powered on, so as to notify the user in a timely manner of the unread information in the mobile terminal.

After the display terminal is powered on, the display terminal will report the power-on state information of the display terminal to the server, and the server will modify the state of the display terminal to Powered On; and the server will detect the state of the corresponding display terminal in the buffer area periodically according to the identifier information of the display terminal, and push the unread information bound with the identifier information of the display terminal to the corresponding display terminal upon determining that the state of the corresponding display terminal is Powered On.

In an embodiment of the disclosure, the state information of the display terminal can be inquired about in the server to determine whether the display terminal has been powered on, where the Powered On state of the display terminal is identified as 0, and the Powered Off state thereof is identified as 1 in the server, so that if the display terminal has been powered on, the display terminal will report the Powered On state information actively to the server, and the server will modify the state identifier of the display terminal to 0 upon reception of the Powered On state information; and if the display terminal has been powered off, the display terminal will report the Powered Off state information actively to the server, and the server will modify the state identifier of the display terminal to 1 upon reception of the Powered Off state information.

In the embodiment above of the disclosure, the unread information and the display terminal can be bound and stored in the buffer area instead of the memory of the server to thereby make full use of the storage space of the server and improve the utilization efficiency of the server.

Here in the operation S103, if the unread information reported by the mobile terminal has been pushed to the display terminal, and the unread information is stored in the buffer area of the server, then the server will wait for feedback information reported by the display terminal to be received, and delete the unread information in the buffer area upon reception of the feedback information reported by the terminal.

In the embodiment above of the disclosure, preferably the display terminal reports the feedback information to the server immediately upon reception of the unread information sent by the server, to indicate that the display terminal has received the unread information, and upon reception of the feedback information, the server locates the unread information corresponding to the identifier of the terminal according to the identifier of the terminal, and deletes the unread information.

An embodiment of the disclosure provides a method for notifying a mobile terminal of unread information as illustrated in FIG. 2, where the method includes:

S201. The mobile terminal reports an identifier information of a display terminal to a server so that the server binds the mobile terminal with the display terminal according to the reported identifier information of the display terminal; and

S202. The mobile terminal reports the unread information to the server upon detection of the unread information so that the server pushes the unread information to the display terminal bound with the mobile terminal.

Optionally in S201, the server is an LETV server, and the display terminal is an LETV TV.

Optionally an application of an LETV TV service has been installed in both the mobile terminal and the display terminal, where the LETV TV service is an application of the mobile terminal, and can be downloaded and installed from a variety of predominant application markets.

Here in S201, the mobile terminal determines the identifier information of the display terminal as follows:

The mobile terminal obtains a two-dimensional code through a camera module, and then recognizes information corresponding to the two-dimensional code; and

The mobile terminal determines the recognized information as the identifier information of the display terminal upon determining that the recognized information conforms with the identifier information of the display terminal.

In the embodiment above of the disclosure, if a user accesses the display terminal, then the display terminal will ask the user whether to hind the mobile terminal, and if the user decides to bind the mobile terminal, then the display terminal will display the two-dimensional code information, and after the display terminal scans the two-dimensional code, then the display terminal will firstly determine whether the two-dimensional code information conforms with the identifier information of the display terminal, and if the two-dimensional code information conforms with the identifier information of the display terminal, then the mobile terminal will determine the recognized information as the identifier information of the display terminal, so that if there are a number of two-dimensional codes of the display terminal, then the identifier information of the display terminal can be recognized, and the recognized information can be determined as the identifier information of the display terminal.

A strip code can be scanned or a mobile phone number can be entered manually and associated with the mobile identifier information of the display terminal instead of associating the display terminal with the mobile terminal by scanning the two-dimensional code information.

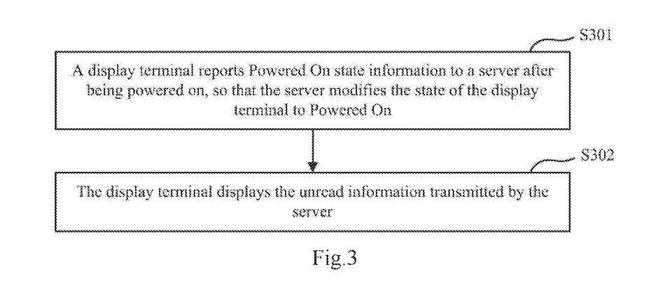

An embodiment of the disclosure provides a method for notifying a mobile terminal of unread information as illustrated in FIG. 3, where the method includes:

S301. A display terminal reports Powered On state information to a server after being powered on, so that the server modifies the state of the display terminal to Powered On; and

S302. The display terminal displays the unread information transmitted by the server.

Here in S301, the unread information is unread information of the mobile terminal bound with the display terminal, and the unread information is transmitted by the server upon reception of the unread information of the mobile terminal bound with the display terminal which has been powered on.

Here before S301, further the mobile terminal needs to be bound with the display terminal, and if a user accesses the display terminal, then the display terminal will ask the user whether to bind the mobile terminal, and if the user decides to bind the mobile terminal, then the display terminal will display two-dimensional code information, and the mobile terminal will scan the two-dimensional code through a camera of the mobile phone to obtain identifier information of the display terminal.

Optionally after S302, the display terminal creates a dialog box asking the user whether to display the unread information, and if the user decides to display the unread information, then the display terminal will display the unread information.

In an embodiment of the disclosure, the display terminal can create the dialog box notifying the user of the unread information and asking the user whether to load the unread information, or the display terminal can newly create an tip icon on a screen of the display terminal to notify the user of the unread information, or the display terminal can scroll amide bar or an upper or lower bar on the screen of the display terminal to notify the user of the unread information.

Optionally in S302, the display terminal transmits feedback information to the server upon reception of the unread information pushed by the server, so that the server deletes the unread information in a buffer area upon reception of the feedback information.

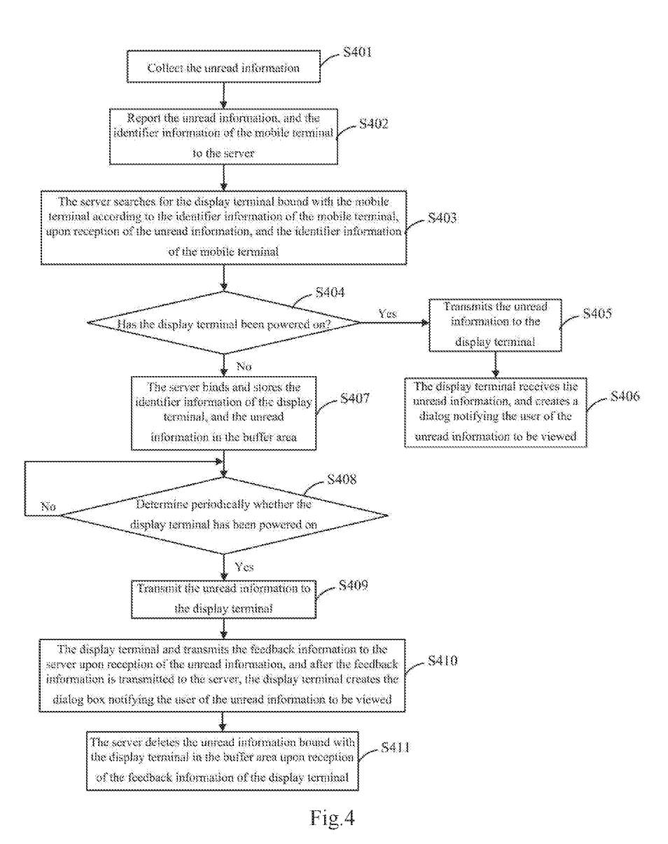

In order to facilitate understanding by those skilled in the art, FIG. 4 illustrates a method for notifying a mobile terminal of unread information according to an embodiment of the disclosure as exemplified below, where a server receives the unread information reported by the mobile terminal; the server determines a display terminal bound with the mobile terminal according to a binding relationship between the mobile terminal and the display terminal; and the server pushes the unread information reported by the mobile terminal to the display terminal bound with the mobile terminal upon determining that the display terminal has been powered on.

In an embodiment of the disclosure, the display terminal is a network TV, a notebook computer, or a tablet computer, and the mobile terminal is a mobile phone, a notebook computer, or a wearable intelligent device.

If a user need to bind the mobile terminal with the display terminal, then the display terminal can display two-dimensional code information, and the mobile terminal can scan the two-dimensional code information through a camera, and determine that the recognized information in the two-dimensional code conforms with identifier information of the display terminal, and thus determine the recognized information as the identifier information of the display terminal.

The mobile terminal scans the two-dimensional code to obtain an address of the server, and the identifier information of the display terminal, and uploads identifier information of the mobile terminal, and the identifier information of the display terminal to the server.

Upon reception of the identifier information of the mobile terminal, and the identifier information of the display terminal, the server creates a binding relationship index table of the mobile terminal and the display terminal, and stores the table in a database.

If there is unread information in the mobile terminal, then the mobile terminal will collect the unread information, and upload the identifier information of the mobile terminal, and the unread information into the server, and the server will search the stored binding relationship table for the display terminal bound with the mobile terminal upon reception of the unread information, and the identifier information of the mobile terminal.

The server detects state information of the display terminal, and if the state of the display terminal is Powered On, then the server will push the unread information reported by the mobile terminal to the display terminal; and if the server detects the state of the display terminal as Powered Off, then the server will bind and store the unread information, and the identifier information of the display terminal in a buffer area, and modify the state of the corresponding display terminal in the server to Powered On upon reception of Powered On state information reported by the display terminal. The server detects the state of the corresponding display terminal in the buffer area periodically according to the identifier information of the display terminal, and pushes the unread information bound with the identifier information of the display terminal to the display terminal upon determining that the state of the corresponding display terminal is Powered On.

The display terminal transmits feedback information to the server upon reception of the unread information, and the server deletes the unread information from the buffer area upon reception of the feedback information of the display terminal; and the display terminal settles the unread information, and then creates a dialog box asking the user whether to view the unread information, and if the user decides to view the unread information, then the display terminal will display the unread information.

FIG. 4 illustrates a flow chart of the method for notifying a mobile terminal of unread information according to an embodiment of the disclosure where there is unread information in the mobile terminal after the mobile terminal has been bound with the display terminal in the server.

S401. The mobile terminal collects the unread information, and proceeds to S402;

S402. The mobile terminal reports the unread information, and the identifier information of the mobile terminal to the server, and proceeds to S403;

S403. The server inquires the relationship index table of the mobile terminal and the display terminal stored in the server, and searches the index table for the display terminal bound with the mobile terminal according to the identifier information of the mobile terminal, upon reception of the unread information, and the identifier information of the mobile terminal, and proceeds to S404;

S404. The server determines whether the display terminal has been powered on, and if the display terminal has been powered on, that is, the state information of the display terminal in the server is Powered On, then the server will proceed to S405; otherwise, the server will proceed to S407;

S405. The server transmits the unread information to the display terminal, and proceeds to S406;

S406. The display terminal receives the unread information, and creates a dialog notifying the user of the unread information to be viewed;

S407. The server binds and stores the identifier information of the display terminal, and the unread information in the buffer area, and proceeds to S408;

S408. The server determines periodically whether the display terminal has been powered on, and if the display terminal has been powered on, then the server will proceed to S409; otherwise, the server will proceed to S408;

S409. The server transmits the unread information to the display terminal;

S410. The display terminal receives the unread information, and transmits the feedback information to the server, and after the feedback information is transmitted to the server, the display terminal creates the dialog box notifying the user of the unread information to be viewed; and

S411. The server deletes the unread information bound with the display terminal in the buffer area upon reception of the feedback information of the display terminal.

Further to the flows of the methods above, embodiments of the disclosure further include a number of apparatuses, and reference can be made to the embodiments above of the methods for details of these apparatuses, so a repeated description thereof will be omitted here.

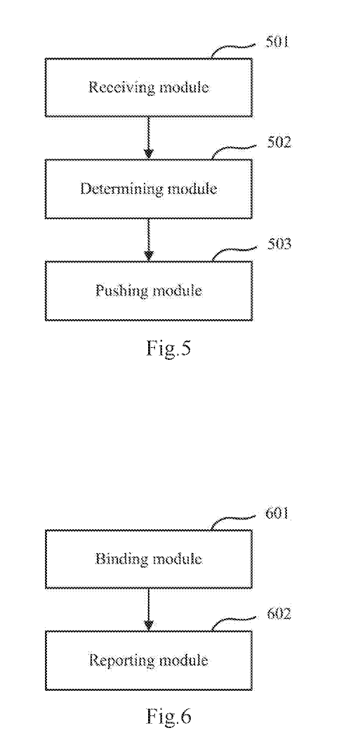

An embodiment of the disclosure provides an apparatus for notifying a mobile terminal of unread information as illustrated in FIG. 5, where the apparatus includes:

A receiving module 501 is configured to receive the unread information reported by the mobile terminal;

A determining module 502 is configured to determine a display terminal bound with the mobile terminal according to a binding relationship between the mobile terminal and the display terminal; and

A pushing module 503 is configured to push the unread information reported by the mobile terminal, to the display terminal bound with the mobile terminal upon determining that the display terminal has been powered on.

Here the unread information received in the receiving module 501 includes one or more of:

Unread call information;

Unread short message information; and

Unread e-mail information.

Here after the receiving module receives the unread information reported by the mobile terminal, the determining module 502 searches a server for the display terminal bound with the mobile terminal according to a terminal identifier of the mobile terminal reporting the unread information, and determines the display terminal bound with the mobile terminal.

Here the determining module 502 is further configured, if the display terminal bound with the mobile terminal has been powered on to bind and store the identifier of the display terminal; and the unread information in a buffer area;

To modify the state of the corresponding display terminal to Powered On upon reception of Powered On state information reported by the mobile terminal; and

To detect the state of the corresponding display terminal in the buffer area periodically according to the identifier information of the display terminal, and to push the unread information bound with the identifier information of the display terminal to the corresponding display terminal upon determining that the state of the corresponding display terminal is Powered On.

In the embodiment above of the disclosure, if the apparatus receives the unread information reported by the mobile terminal, then the apparatus will search for the display terminal bound with the mobile terminal using the identifier of the mobile terminal and push the unread information to the display terminal; and if the display terminal has been powered off, then the apparatus will bind and store the identifier information of the display terminal and the read information in the buffer area.

After the display terminal is powered on, the apparatus receives the reported Powered On state information of the display terminal, and modifies the state of the display terminal to Powered On; and the apparatus detects the state of the corresponding display terminal in the buffer area periodically according to the identifier information of the display terminal, and pushes the unread information bound with the identifier of the display terminal to the corresponding display terminal upon determining that the state of the corresponding display terminal is Powered On.

Optionally if the state of the corresponding display terminal is determined as Powered On, then the apparatus will receive a feedback transmitted by the display terminal that the unread information bound with the identifier of the display terminal has been received, and delete the unread information, after the unread information is pushed to the corresponding display terminal.

Here the determining module 502 configured to create the binding relationship between the mobile terminal and the display terminal is configured:

To bind the display terminal corresponding to the identifier of the display terminal with the mobile terminal upon reception of the identifier information of the display terminal reported by the mobile terminal.

In the embodiment above of the disclosure, the apparatus determines for the reporting mobile terminal the identifier of the mobile terminal, creates a relationship index table between the display terminal and the mobile terminal in the server according to the identifier of the display terminal reported by the mobile terminal, and the identifier of the mobile terminal, and stores the table in a database of the server.

An embodiment of the disclosure provides a user equipment for notifying a mobile terminal of unread information as illustrated in FIG. 6, where the user equipment includes:

A binding module 601 is configured to report an identifier information of a display terminal to a server so that the server binds the mobile terminal with the display terminal according to the reported identifier information of the display terminal; and

A reporting module 602 is configured to report the unread information to the server upon detection of the unread information so that the server pushes the unread information to the display terminal bound with the mobile terminal.

Here the binding module 602 is further configured:

To obtain a two-dimensional code through a camera module, and then recognize information corresponding to the two-dimensional code; and

To determine the recognized information as the identifier information of the display terminal upon determining that the recognized information conforms with the identifier information of the display terminal.

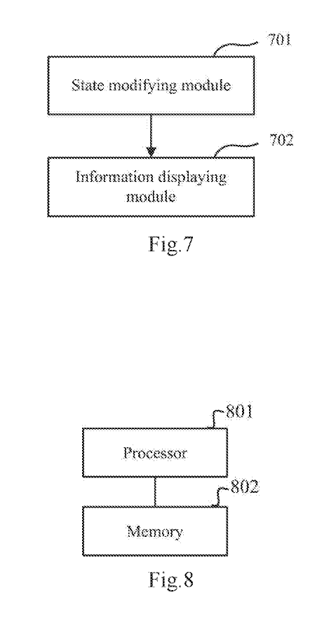

An embodiment of the disclosure provides a display terminal for notifying a mobile terminal about unread information as illustrated in FIG. 7, where the display terminal includes:

A state modifying module 701 is configured to report Powered On state information to a server after the display terminal is powered on, so that the server modifies the state of the display terminal to Powered On; and

An information displaying module 702 is configured to display the unread information transmitted by the server.

Where the unread information is unread information of the mobile terminal bound with the display terminal, and the unread information is transmitted by the server upon reception of the unread information of the mobile terminal bound with the display terminal which has been powered on.

FIG. 8 illustrates a schematic structural diagram of an electronic device in accordance with some embodiments, wherein the electronic device includes:

at least one processor 801; and

a memory 802 communicably connected with the at least one processor for storing instructions executable by the at least one processor, wherein execution of the instructions by the at least one processor causes the at least one processor to:

receive, by a server, the unread information reported by the mobile terminal;

determine, by the server, a display terminal bound with the mobile terminal according to a binding relationship between the mobile terminal and the display terminal; and

push, by the server, the unread information reported by the mobile terminal, to the display terminal bound with the mobile terminal upon determining that the display terminal has been powered on.

Wherein after the server determines the display terminal bound with the mobile terminal according to the binding relationship between the mobile terminal and the display terminal, the at least one processor is further caused to:

if the display terminal bound with the mobile terminal has been powered off, then bind and store, by the server, an identifier information of the display terminal, and the unread information in a buffer area;

modify, by the server, the state of the corresponding display terminal to Powered On upon reception of Powered On state information reported by the display terminal; and

detect, by the server, the state of the corresponding display terminal in the buffer area periodically according to the identifier information of the display terminal; and push the unread information hound with the identifier information of the display terminal to the display terminal upon determining that the state of the corresponding display terminal is Powered On.

Wherein create, by the server, the binding relationship between the mobile terminal and the display terminal includes:

binding, by the server, the display terminal corresponding to the identifier of the display terminal with the mobile terminal upon reception of the identifier information of the display terminal reported by the mobile terminal.

Wherein the unread information comprise one or more of:

unread call information;

unread short message information; and

unread e-mail information.

The at least one processor is further caused to:

obtain, by the mobile terminal, a two-dimensional code through a camera module, and then recognize information corresponding to the two-dimensional code; and

determine, by the mobile terminal; the recognized information as an identifier information of the display terminal upon determining that the recognized information conforms with the identifier information of the display terminal.

Wherein the unread information transmitted by the server is displayed by the display terminal, and the unread information is unread information of the mobile terminal bound with the display terminal.

An embodiment of the invention disclosure provides a non-transitory computer-readable storage medium storing executable instructions that, when executed by an electronic device with a touch-sensitive display, cause the electronic device to:

receive, by a server, the unread information reported by the mobile terminal;

determine, by the server, a display terminal bound with the mobile terminal according to a binding relationship between the mobile terminal and the display terminal; and

push, by the server, the unread information reported by the mobile terminal, to the display terminal bound with the mobile terminal upon determining that the display terminal has been powered on.

After the server determines the display terminal bound with the mobile terminal according to the binding relationship between the mobile terminal and the display terminal, the non-transitory computer-readable storage medium further cause the electronic device to:

if the display terminal bound with the mobile terminal has been powered oft, then bind and store, by the server, an identifier information of the display terminal, and the unread information in a buffer area;

modify, by the server, the state of the corresponding display terminal to Powered On upon reception of Powered On state information reported by the display terminal; and

detect, by the server, the state of the corresponding display terminal in the buffer area periodically according to the identifier information of the display terminal, and push the unread information hound with the identifier information of the display terminal to the display terminal upon determining that the state of the corresponding display terminal is Powered On.

wherein create, by the server, the binding relationship between the mobile terminal and the display terminal includes:

binding, by the server, the display terminal corresponding to the identifier of the display terminal with the mobile terminal upon reception of the identifier information of the display terminal reported by the mobile terminal.

Wherein the unread information comprise one or more of:

unread call information;

unread short message information; and

unread e-mail information.

The non-transitory computer-readable storage medium further cause the electronic device to:

obtain, by the mobile terminal, a two-dimensional code through a camera module, and then recognize information corresponding to the two-dimensional code; and

determine, by the mobile terminal, the recognized information as an identifier information of the display terminal upon determining that the recognized information conforms with the identifier information of the display terminal.

Wherein the unread information transmitted by the server is displayed by the display terminal, and the unread information is unread information of the mobile terminal bound with the display terminal.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatuses described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to apart of the technical features thereof; and these modifications or substitutions to the corresponding technical solution shall also fall into the scope of the disclosure as claimed.

What is claimed is:

1. A method for notifying a mobile terminal of unread information, the method comprising:
receiving, by a server, the unread information reported by the mobile terminal;
determining, by the server, a display terminal bound with the mobile terminal according to a binding relationship between the mobile terminal and the display terminal; and
pushing, by the server, the unread information reported by the mobile terminal, to the display terminal bound with the mobile terminal upon determining that the display terminal has been powered on.

2. The method according to claim 1, wherein after the server determines the display terminal bound with the mobile terminal according to the binding relationship between the mobile terminal and the display terminal, the method further comprises:
if the display terminal bound with the mobile terminal has been powered off, then binding and storing, by the server, an identifier information of the display terminal, and the unread information in a buffer area;
modifying, by the server, the state of the corresponding display terminal to Powered On upon reception of Powered On state information reported by the display terminal; and
detecting, by the server, the state of the corresponding display terminal in the buffer area periodically according to the identifier information of the display terminal, and pushing the unread information bound with the identifier information of the display terminal to the display terminal upon determining that the state of the corresponding display terminal is Powered On.

3. The method according to claim 1, wherein creating, by the server, the binding relationship between the mobile terminal and the display terminal comprises:
binding, by the server, the display terminal corresponding to the identifier of the display terminal with the mobile terminal upon reception of the identifier information of the display terminal reported by the mobile terminal.

4. The method according to claim 1 wherein the unread information comprise one or more of:
unread call information;
unread short message information; and
unread e-mail information.

5. The method according to claim 1, the method further comprising:
obtaining, by the mobile terminal, a two-dimensional code through a camera module, and then recognizing information corresponding to the two-dimensional code; and
determining, by the mobile terminal, the recognized information as an identifier information of the display terminal upon determining that the recognized information conforms with the identifier information of the display terminal.

6. The method according to claim 1, wherein the unread information transmitted by the server is displayed by the display terminal, and the unread information is unread information of the mobile terminal bound with the display terminal.

7. An electronic device, comprising:
at least one processor; and
a memory communicably connected with the at least one processor for storing instructions executable by the at least one processor, wherein execution of the instructions by the at least one processor causes the at least one processor to:
receive, by a server, the unread information reported by the mobile terminal;
determine, by the server, a display terminal bound with the mobile terminal according to a binding relationship between the mobile terminal and the display terminal; and
push, by the server, the unread information reported by the mobile terminal, to the display terminal bound with the mobile terminal upon determining that the display terminal has been powered on.

8. The electronic device according to claim 7, wherein after the server determines the display terminal bound with the mobile terminal according to the binding relationship between the mobile terminal and the display terminal, the at least one processor is further caused to:
if the display terminal bound with the mobile terminal has been powered off, then bind and store, by the server, an identifier information of the display terminal, and the unread information in a buffer area;
modify, by the server, the state of the corresponding display terminal to Powered On upon reception of Powered On state information reported by the display terminal; and
detect, by the server, the state of the corresponding display terminal in the buffer area periodically according to the identifier information of the display terminal, and push the unread information bound with the identifier information of the display terminal to the display terminal upon determining that the state of the corresponding display terminal is Powered On.

9. The electronic device according to claim 7, wherein create, by the server, the binding relationship between the mobile terminal and the display terminal comprises:
binding, by the server, the display terminal corresponding to the identifier of the display terminal with the mobile terminal upon reception of the identifier information of the display terminal reported by the mobile terminal.

10. The electronic device according to claim 7, wherein the unread information comprise one or more of:
unread call information;
unread short message information; and
unread e-mail information.

11. The electronic device according to claim 7, the at least one processor is further caused to:
obtain, by the mobile terminal, a two-dimensional code through a camera module, and then recognize information corresponding to the two-dimensional code; and
determine, by the mobile terminal, the recognized information as an identifier information of the display terminal upon determining that the recognized information conforms with the identifier information of the display terminal.

12. The electronic device according to claim 7, wherein the unread information transmitted by the server is displayed by the display terminal, and the unread information is unread information of the mobile terminal bound with the display terminal.

13. A non-transitory computer-readable storage medium storing executable instructions that, when executed by an electronic device with a touch-sensitive display, cause the electronic device to:
receive, by a server, the unread information reported by the mobile terminal;
determine, by the server, a display terminal bound with the mobile terminal according to a binding relationship between the mobile terminal and the display terminal; and
push, by the server, the unread information reported by the mobile terminal, to the display terminal bound with the mobile terminal upon determining that the display terminal has been powered on.

14. The non-transitory computer-readable storage medium according to claim 13, after the server determines the display terminal bound with the mobile terminal according to the binding relationship between the mobile terminal and the display terminal, further cause the electronic device to:
if the display terminal bound with the mobile terminal has been powered off, then bind and store, by the server, an identifier information of the display terminal, and the unread information in a buffer area;
modify, by the server, the state of the corresponding display terminal to Powered On upon reception of Powered On state information reported by the display terminal; and
detect, by the server, the state of the corresponding display terminal in the buffer area periodically according to the identifier information of the display terminal, and push the unread information bound with the identifier information of the display terminal to the display terminal upon determining that the state of the corresponding display terminal is Powered On.

15. The non-transitory computer-readable storage medium according to claim 13, wherein create, by the server, the binding relationship between the mobile terminal and the display terminal comprises:
binding, by the server, the display terminal corresponding to the identifier of the display terminal with the mobile terminal upon reception of the identifier information of the display terminal reported by the mobile terminal.

16. The non-transitory computer-readable storage medium according to claim 13, wherein the unread information comprise one or more of:
unread call information;
unread short message information; and
unread e-mail information.

17. The non-transitory computer-readable storage medium according to claim 13, further cause the electronic device to:
obtain, by the mobile terminal, a two-dimensional code through a camera module, and then recognize information corresponding to the two-dimensional code; and
determine, by the mobile terminal, the recognized information as an identifier information of the display terminal upon determining that the recognized information conforms with the identifier information of the display terminal.

18. The non-transitory computer-readable storage medium according to claim 13, wherein the unread information transmitted by the server is displayed by the display terminal, and the unread information is unread information of the mobile terminal bound with the display terminal.
